(19) United States
(12) Patent Application Publication
(10) Pub. No.: US 2016/0142619 A1
(43) Pub. Date: May 19, 2016

(54) FOCUS CONTROL APPARATUS, IMAGE CAPTURING APPARATUS, METHOD FOR CONTROLLING FOCUS CONTROL APPARATUS AND STORAGE MEDIUM

(71) Applicant: CANON KABUSHIKI KAISHA, Tokyo (JP)

(72) Inventor: Akihiko Kanda, Kawasaki-shi (JP)

(21) Appl. No.: 14/929,993

(22) Filed: Nov. 2, 2015

(30) Foreign Application Priority Data
Nov. 14, 2014 (JP) 2014-231972

(51) Int. Cl. H04N 5/232; G06K 9/46; G06T 7/40; G06T 7/00

(52) U.S. Cl. CPC H04N 5/23212; G06T 7/0042; G06K 9/4661; G06K 9/4652; G06T 7/408; G06K 2009/4666

(57) ABSTRACT

There is provided a focus control apparatus. A first extraction unit extracts frequency components of a first band from a predetermined evaluation area of image data generated by an image capturing unit. A change unit changes the evaluation area based on the frequency components extracted by the first extraction unit, so that the evaluation area after the change is narrower than the evaluation area before the change. A second extraction unit extracts, from the evaluation area after the change, frequency components of a second band that includes a higher band than the first band. A calculation unit calculates a focus evaluation value for performing focus control of the image capturing unit based on the frequency components extracted by the second extraction unit.

### BACKGROUND OF THE INVENTION

1. Field of the Invention

The present invention relates to a focus control apparatus, an image capturing apparatus, a method for controlling the focus control apparatus, and a storage medium.

2. Description of the Related Art

In image capturing apparatuses such as digital cameras and video cameras, a contrast AF method for detecting a focus position based on the sharpness (contrast) of captured image signals obtained from an image sensor such as a CCD or a CMOS is widely used. Specifically, the image capturing apparatus calculates contrast evaluation values indicating the degree of a contrast for captured image signals obtained by sequentially capturing an object while moving a focus lens. Then, a position of the focus lens where the contrast is the highest is designated as a focus position based on the contrast evaluation values, and the focus position is searched for by moving the focus lens in the optical axis direction.

As a document disclosing a technique for detecting a focus position, Japanese Patent Laid-Open No. 7-190718 is known. Japanese Patent Laid-Open No. 7-190718 discloses performing a search starting from captured image data with less noise in order to detect a position that first exceeds a predetermined threshold as an edge position, and detecting, as a focus position, a focus direction position at which a contrast value at the edge position indicates a peak.

In the case of performing the contrast AF on an object with low illuminance or low contrast, a correct focus position cannot be detected in some cases due to an S/N ratio of contrast evaluation values decreasing. For example, in the case of using the technique described in Japanese Patent Laid-Open No. 7-190718 on such an object, there is the possibility that a noise generation position is erroneously detected as an edge position and as a result, a correct focus position cannot be detected.

### SUMMARY OF THE INVENTION

The present invention has been made in light of such a situation, and provides a technique for improving accuracy of focus control.

According to a first aspect of the present invention, there is provided a focus control apparatus comprising: a first extraction unit configured to extract frequency components of a first band from a predetermined evaluation area of image data generated by an image capturing unit; a change unit configured to change the evaluation area based on the frequency components extracted by the first extraction unit, so that the evaluation area after the change is narrower than the evaluation area before the change; a second extraction unit configured to extract, from the evaluation area after the change, frequency components of a second band that includes a higher band than the first band; and a calculation unit configured to calculate a focus evaluation value for performing focus control of the image capturing unit based on the frequency components extracted by the second extraction unit.

According to a second aspect of the present invention, there is provided an image capturing apparatus comprising: an image capturing unit; a first extraction unit configured to extract frequency components of a first band from a predetermined evaluation area of image data generated by the image capturing unit; a change unit configured to change the evaluation area based on the frequency components extracted by the first extraction unit, so that the evaluation area after the change is narrower than the evaluation area before the change; a second extraction unit configured to extract, from the evaluation area after the change, frequency components of a second band that includes a higher band than the first band; and a calculation unit configured to calculate a focus evaluation value for performing focus control of the image capturing unit based on the frequency components extracted by the second extraction unit.

According to a third aspect of the present invention, there is provided a method for controlling a focus control apparatus, comprising: a first extraction step of extracting frequency components of a first band from a predetermined evaluation area of image data generated by an image capturing unit; a change step of changing the evaluation area based on the frequency components extracted in the first extraction step, so that the evaluation area after the change is narrower than the evaluation area before the change; a second extraction step of extracting, from the evaluation area after the change, frequency components of a second band that includes a higher band than the first band; and a calculation step of calculating a focus evaluation value for performing focus control of the image capturing unit based on the frequency components extracted in the second extraction step.

According to a fourth aspect of the present invention, there is provided a non-transitory computer-readable storage medium which stores a program for causing a computer to execute a method for controlling a focus control apparatus, the method comprising: a first extraction step of extracting frequency components of a first band from a predetermined evaluation area of image data generated by an image capturing unit; a change step of changing the evaluation area based on the frequency components extracted in the first extraction step, so that the evaluation area after the change is narrower than the evaluation area before the change; a second extraction step of extracting, from the evaluation area after the change, frequency components of a second band that includes a higher band than the first band; and a calculation step of calculating a focus evaluation value for performing focus control of the image capturing unit based on the frequency components extracted in the second extraction step.

Further features of the present invention will become apparent from the following description of exemplary embodiments with reference to the attached drawings.

### BRIEF DESCRIPTION OF THE DRAWINGS

FIG. 1 is a block diagram showing a configuration of an image capturing apparatus 100 including a focus control apparatus.

FIG. 2 is a block diagram showing a configuration of a contrast signal processing circuit 124.

FIG. 3 is a diagram showing line peak positions of contrast evaluation values in an evaluation area of a low contrast object under low illumination.

FIG. 4 is a diagram showing contrast evaluation values corresponding to a line B of the evaluation area shown in FIG. 3.

FIG. 5 is a diagram showing a comparison of line peak positions corresponding to a high-pass filter before and after changing the evaluation area.

FIG. 6 is a flowchart of AF processing executed by the image capturing apparatus 100.

FIG. 7 is a flowchart of processing for ON/OFF setting of evaluation area change in step S106 in FIG. 6.

FIG. 8 is a flowchart of processing for evaluation area change in step S108 in FIG. 6.

### DESCRIPTION OF THE EMBODIMENTS

Embodiments of the present invention will now be described with reference to the attached drawings. It should be noted that the technical scope of the present invention is defined by the claims, and is not limited by any of the embodiments described below. In addition, not all combinations of the features described in the embodiments are necessarily required for realizing the present invention.

### First Embodiment

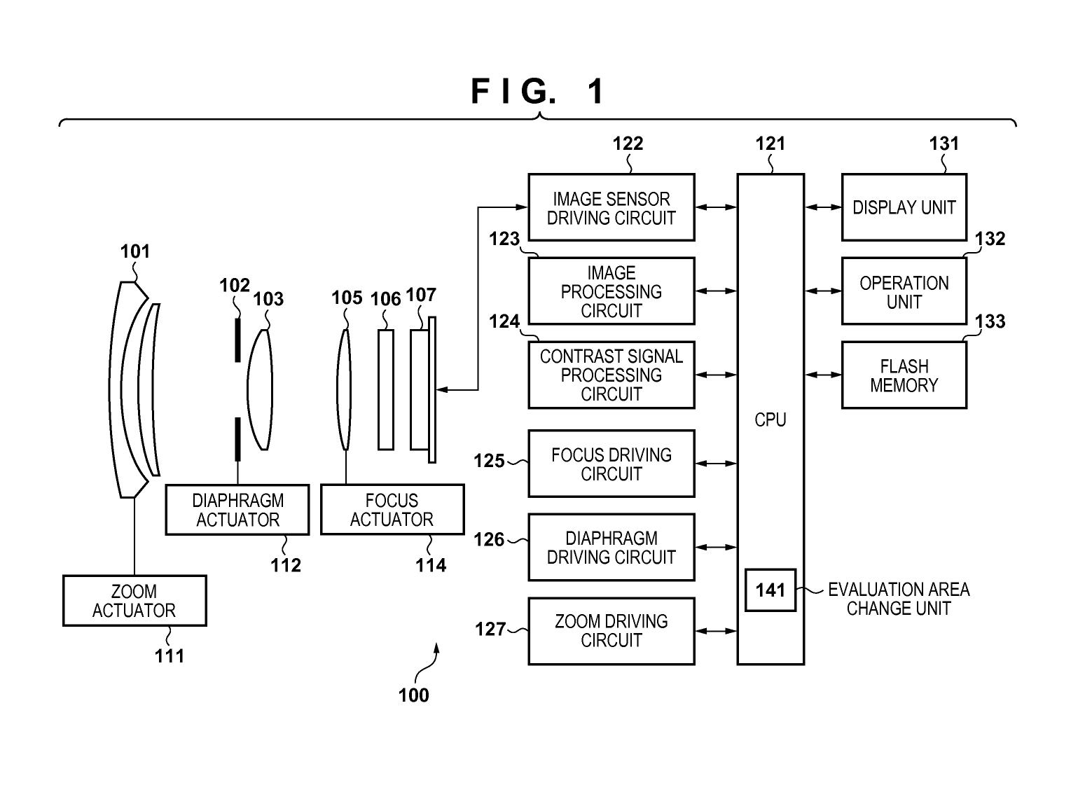

FIG. 1 is a block diagram showing the configuration of the image capturing apparatus 100 including a focus control apparatus. The image capturing apparatus 100 shown in FIG. 1 is in a form of a digital camera in which a camera body including an image sensor is integrated with a shooting optical system, and can record moving images and still images. In FIG. 1, reference numeral 101 indicates a first lens group arranged at the top end of the shooting optical system (image-forming optical system) and held movably in the optical axis direction. Reference numeral 102 indicates a diaphragm mechanism that performs light quantity adjustment during shooting by adjusting the opening diameter thereof, and in addition, is provided with a function as a shutter for exposure time control when shooting a still image. Reference numeral 103 indicates a second lens group. Then, the diaphragm mechanism 102 and the second lens group 103 are integrally driven in the optical axis direction, and produce a power varying action (zoom function), in conjunction with a moving operation of the first lens group 101. Reference numeral 105 indicates a third lens group that performs focus control based on the movement in the optical axis direction. That is, the third lens group serves as a focus lens. Reference numeral 106 indicates an optical low-pass filter that is an optical element for reducing a false color and moire in a captured image.

Reference numeral 107 indicates an image sensor that includes pixels enabling focus detection, and is constituted by a CMOS sensor and the peripheral circuits thereof. The image sensor 107 has light receiving pixels arranged in a rectangle (M pixels in the lateral direction and N pixels in the longitudinal direction), and a two-dimensional single-plate color sensor is used in which primary color mosaic filters in a Bayer array are formed on-chip. The above first lens group 101, diaphragm mechanism 102, second lens group 103, third lens group 105, and optical low-pass filter 106 constitute an image-capturing optical system.

The pixel arrangement of the image sensor 107 in this embodiment will be further described. The Bayer array is applied to the color filters, and pixels in odd-numbered rows have Green and Red color filters alternately arranged in order from the left. Moreover, pixels in even-numbered rows have Blue and Green color filters alternately arranged in order from the left. The image sensor 107 includes an on-chip microlens, and a photoelectric conversion unit is arranged in the on-chip microlens.

The image sensor 107 includes the following two types of read-out modes. A first read-out mode is called full pixel read-out mode and is a mode for capturing a high-definition still image. In this case, signals of all the pixels are read out. A second read-out mode is called thinned read-out mode and is a mode for only performing moving image recording or display of a preview image. The number of pixels required in this case is less than total pixels, and thus only pixels thinned to a predetermined rate both in X direction and Y direction are read out. Thereby, high-speed reading out is enabled.

Reference numeral 111 indicates a zoom actuator that drives the first lens group 101 to the third lens group 105 in the optical axis direction by rotating a cam tube (not illustrated) manually or using an actuator, and performs a power varying operation. Reference numeral 112 indicates a diaphragm actuator that controls the opening diameter of the diaphragm mechanism 102 to adjust a shooting light quantity and performs the exposure time control when shooting a still image. Reference numeral 114 indicates a focus actuator that drives the third lens group 105 in the optical axis direction and performs focus control.

Reference numeral 121 indicates a CPU that includes a computation unit, a ROM, a RAM, an A/D converter, a D/A converter, a communication interface circuit and the like to perform various types of control of the camera body. Moreover, the CPU 121 drives various circuits included in the image capturing apparatus 100 based on a predetermined program stored in the ROM, and executes a series of operations such as focus control (AF), shooting, image processing, and recording.

Reference numeral 122 indicates an image sensor driving circuit that controls the image capturing operations of the image sensor 107, performs A/D conversion of acquired image signals and transmits the converted signals to the CPU 121. Reference numeral 123 indicates an image processing circuit that performs processing such as color interpolation, y conversion, and image compression on an image acquired by the image sensor 107.

Reference numeral 124 indicates a contrast signal processing circuit that performs filter processing with different evaluation bands on signals from the image sensor driving circuit 122. The contrast signal processing circuit 124 then generates contrast information, a plurality of contrast evaluation values, and line peak positions at which the contrast evaluation value is the largest in each line, which are contrast evaluation positions within an evaluation area.

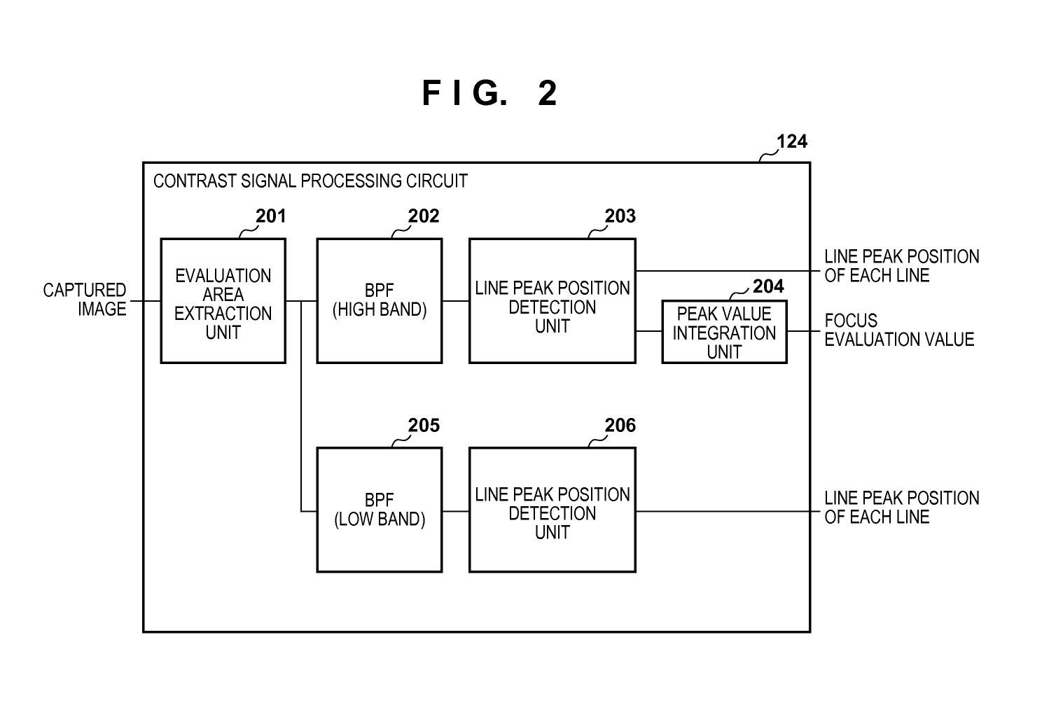

The configuration of the contrast signal processing circuit 124 will be described with reference to FIG. 2. The contrast signal processing circuit 124 calculates focus evaluation values indicating a focus detection state (a degree to which captured image signals in a focus detection area are focused on).

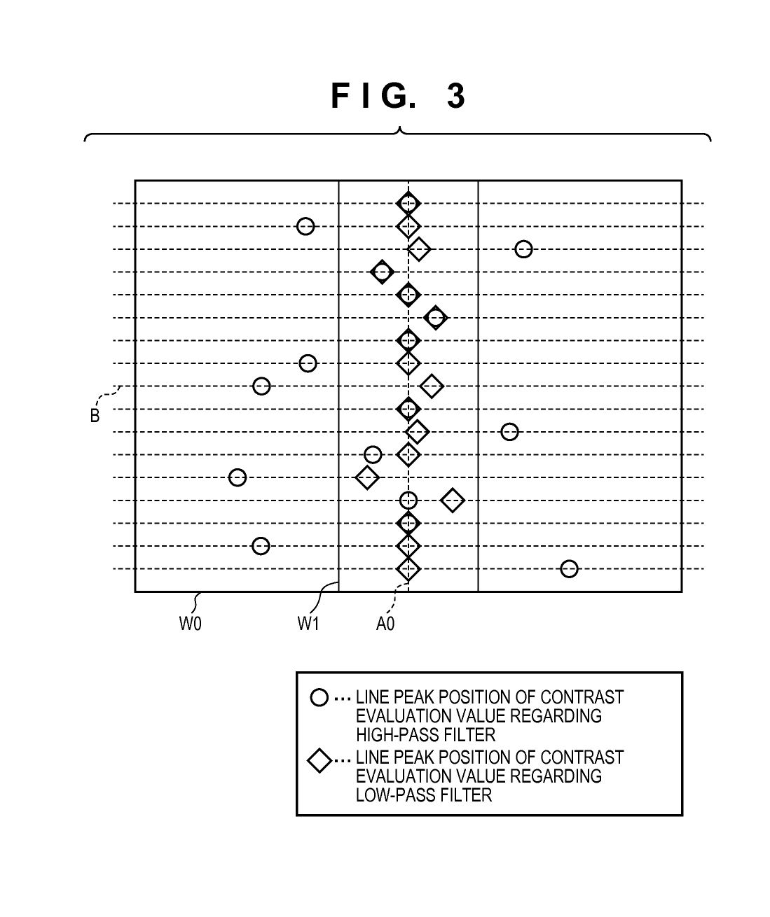

An evaluation area extraction unit 201 extracts, from among the captured image signals (image data) generated by the image sensor 107, captured image signals corresponding to a predetermined evaluation area. A band-pass filter (BPF) 202 extracts high frequency components (frequency components of a second band) from the captured image signals extracted by the evaluation area extraction unit 201. A line peak position detection unit 203 calculates contrast evaluation values of respective pixels based on the high frequency components extracted by the BPF 202, and detects peak positions (line peak positions) of the contrast evaluation values of respective lines in the horizontal direction. The processing executed by the line peak position detection unit 203 will be described in detail later with reference to FIG. 3. A peak value integration unit 204 calculates focus evaluation values by integrating the contrast evaluation values of the line peak positions of the respective lines detected by the line peak position detection unit 203. A BPF 205 extracts low frequency components (frequency components of a first band) from the captured image signals extracted by the evaluation area extraction unit 201. A line peak position detection unit 206 calculates the contrast evaluation values of the respective pixels based on the low frequency components extracted by the BPF 205, and detects peak positions (line peak positions) of the contrast evaluation values of the respective lines in the horizontal direction. The processing executed by the line peak position detection unit 206 will be described in detail later with reference to FIG. 3.

Note that in FIG. 2, the contrast signal processing circuit 124 is shown provided with two separate BPFs, that is, the BPFs 202 and 205. However, the contrast signal processing circuit 124 may be provided with one BPF that can switch a pass band between a high band and a low band. Moreover, the pass band of the BPF 202 includes a higher band than the pass band of BPF 205, but it is not necessary to block the pass band of the BPF 205. That is, the pass band of the BPF 202 may include a portion of or entire pass band of the BPF 205. Furthermore, the direction of lines of line peak positions detected by the line peak position detection units 203 and 206 may be a vertical direction instead of a horizontal direction.

Returning to FIG. 1, reference numeral 125 indicates a focus driving circuit that performs drive control on the focus actuator 114 based on focus evaluation values and performs focus control by driving the third lens group 105 in the optical axis direction. The drive control (AF control) based on the focus evaluation values will be described later. Reference numeral 126 indicates a diaphragm driving circuit that performs drive control on the diaphragm actuator 112 and controls the opening of the diaphragm mechanism 102. Reference numeral 127 indicates a zoom driving circuit that drives the zoom actuator 111 in accordance with a zoom operation by a photographer.

Reference numeral 131 indicates a display unit that includes an LCD or the like and displays information on a shooting mode of the image capturing apparatus 100, a preview image while shooting, an image for checking after shooting, a focus state display image at the time of focus detection, and the like. Reference numeral 132 indicates an operation unit that includes an operation switch and the like and is constituted by a power supply switch, a shooting start switch, a zoom operation switch, a shooting mode selection switch and the like. Reference numeral 133 indicates a detachable flash memory that stores shot images including a moving image and a still image.

Reference numeral 141 indicates an evaluation area change unit that performs change control on an evaluation area set during an AF operation. In particular, the evaluation area change unit 141 changes the evaluation area based on a result of the contrast signal processing circuit 124 detecting, using a filter with different evaluation bands, line peak positions in respective lines within the evaluation area set during an AF operation.

Next, the contrast AF method will be described. As described with reference to FIG. 2, the contrast signal processing circuit 124 calculates focus evaluation values based on high frequency components of an evaluation area. The contrast signal processing circuit 124 also calculates not only the focus evaluation values but also other contrast information. The other contrast information includes a maximum value of high frequency components of luminance levels of image signals within the evaluation area, the difference between a maximum value and a minimum value of luminance levels of image signals within the evaluation area, and the like. Furthermore, in this embodiment, the contrast signal processing circuit 124 detects peak positions (line peak positions) of the contrast evaluation values for respective lines in the horizontal direction within the evaluation area.

Detection of a focus position using the contrast AF method is performed in the following procedure. The image capturing apparatus 100 performs a scanning operation in which the third lens group 105 is moved in the optical axis direction, searches for a direction in which a focus evaluation value increases, and moves the third lens group 105 in that direction. Then, the image capturing apparatus 100 acquires focus evaluation values until an acquired focus evaluation value reaches a maximum value and then turns to decrease. Focus determination is performed using three or four points with the largest focus evaluation values. The image capturing apparatus 100 can calculate a focus lens position (focus position) at which the focus evaluation value takes a maximum value by performing interpolation calculation based on the focus lens positions corresponding to those points, so as to move the third lens group 105 to the focus position.

There is the possibility that a correct focus position for an object with low illumination or low contrast cannot be detected using the contrast AF method due to the S/N ratio of the focus evaluation values decreasing. In this embodiment, it is possible to improve the accuracy of search for a focus position by changing the evaluation area based on the line peak positions of the contrast evaluation values of respective horizontal lines within the evaluation area corresponding to a filter with a low evaluation band (the BPF 205 in FIG. 2).

FIG. 3 is a diagram showing line peak positions of contrast evaluation values in an evaluation area of a low contrast object under low illumination. In FIG. 3, dotted lines in the horizontal direction indicate evaluation lines.

Circles (∘) indicate line peak positions whose evaluation band corresponds to a high frequency pass filter (the BPF 202 in FIG. 2), and rhomboids (⋄) indicate line peak positions whose evaluation band corresponds to a low frequency pass filter (the BPF 205 in FIG. 2). As seen from FIG. 3, the line peak position detection units 203 and 206 in FIG. 2 each calculate contrast evaluation values corresponding to respective pixels within the evaluation area, and detect a line peak position for each of the lines.

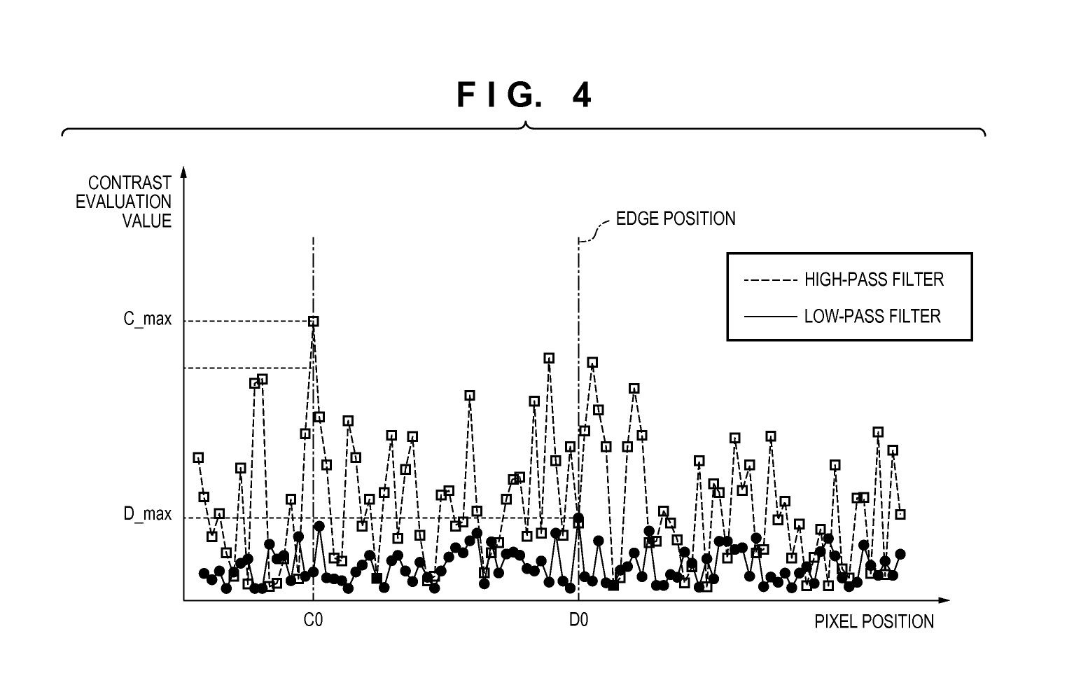

FIG. 4 is a diagram showing contrast evaluation values corresponding to the line B in the evaluation area shown in FIG. 3. In FIG. 4, a vertical axis indicates a contrast evaluation value, and a horizontal axis indicates a pixel position. Moreover, dotted lines correspond to contrast evaluation values obtained using a high-pass filter, and solid lines correspond to contrast evaluation values obtained using a low-pass filter.

As shown in FIG. 4, the low-pass filter, which can remove noise in a high band, can more accurately detect, as a line peak position, an edge position vicinity in which a contrast evaluation value is maximum than the high-pass filter. However, a spatial frequency band of the object and the evaluation band obtained using the low-pass filter are different in band. Therefore, in the case where focus evaluation values are calculated based on the contrast evaluation values obtained using the low-pass filter, there is the possibility that focusing accuracy deteriorates due to the difference that arises between a focus lens position at which the focus evaluation value is maximum and an actual focus position of the object.

In view of this, in this embodiment, the image capturing apparatus 100 performs detection of line peak positions based on low frequency components obtained using the low-pass filter, restricts the evaluation area to the vicinity of the line peak positions, and then calculates focus evaluation values based on high frequency components obtained using the high-pass filter. Specifically, as shown in FIG. 3, the image capturing apparatus 100 detects the line peak positions for an evaluation area W0 based on the frequency components extracted using the low-pass filter. Subsequently, using the detected line peak positions as references, the image capturing apparatus 100 sets an evaluation area W1 so as to have a width over a certain range in the horizontal direction. For example, as shown in FIG. 3, the evaluation area W1 is set to be narrower than the evaluation area W0, to be centered on a vertical line A0 on which line peak positions corresponding to the low-pass filter are concentrated, and to include all the line peak positions corresponding to the low-pass filter. By reducing the evaluation area in the horizontal direction in this manner, it is possible to reduce the possibility to use contrast evaluation values of line peak positions far away from the edge position of the object (for example, a circle (∘) on the line B in FIG. 3) when calculating focus evaluation values.

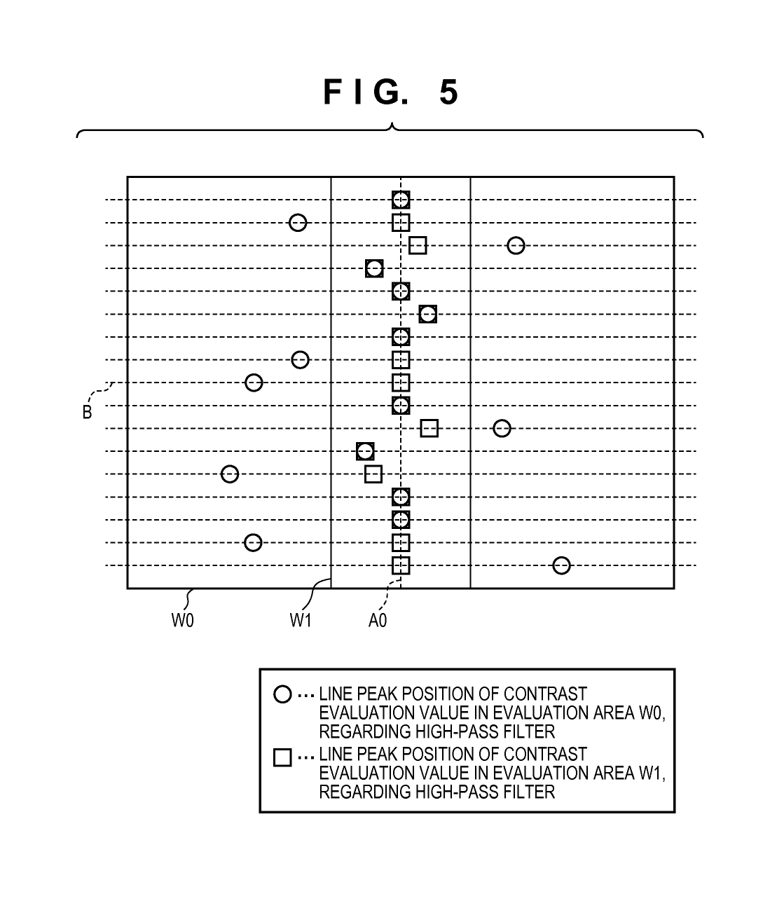

FIG. 5 is a diagram showing a comparison of line peak positions before and after changing the evaluation area, the line peak positions corresponding to the high-pass filter. In FIG. 5, circles (∘) indicate the line peak positions before changing evaluation area (the evaluation area W0), and this is the same as that shown in FIG. 3. Moreover, squares (□) indicate line peak positions after changing the evaluation area (the evaluation area W1). For example, on the line B, before changing the evaluation area, the line peak positions are present at positions far away from the vertical line A0 that is in the vicinity of the edge position of the object, however, after changing the evaluation area, the line peak positions are moved to be on the vertical line A0. By changing the evaluation area based on the line peak positions corresponding to the low-pass filter in this manner, the possibility that focus evaluation values are calculated based on line peak positions erroneously detected due to noise or the like (e.g., a circle (∘) on the line B) is reduced. Moreover, because the contrast evaluation values based on the frequency components extracted using the high-pass filter are used when calculating the focus evaluation values, the focus evaluation values can be calculated in a band including a large number of spatial frequencies of the object. As a result, focusing accuracy improves.

Note that in the example in FIG. 5, the evaluation area is changed so as to include the line peak positions corresponding to the low-pass filter, however, the evaluation area may be changed so as to include not only the line peak position, but also positions at which the contrast evaluation value is second or third largest. Moreover, instead of changing the evaluation area so as to include line peak positions of all the lines, the evaluation area may be changed so as to include line peak positions of lines at which the line peak value is greater than or equal to a threshold. As this threshold, for example, an average value of the line peak values of the evaluation area W0 that correspond to the low-pass filter can be used.

Moreover, as for the examples in FIGS. 3 to 5, description was given in which the contrast signal processing circuit 124 detects a peak position of the contrast evaluation value for each line based on low frequency components, but detection for each line is not necessary. For example, in a simpler configuration, the contrast signal processing circuit 124 may detect a position in the evaluation area W0 at which the contrast evaluation value is maximum, based on the low frequency components. In this case, the evaluation area change unit 141 can change the evaluation area so that the evaluation area after the change includes a position in the evaluation area W0 at which the contrast evaluation value is maximum.

The evaluation area change unit 141 may also change a range over which the evaluation area is narrowed in accordance with the evaluation band obtained using the low-pass filter. In the case where the evaluation band obtained using the low-pass filter is low, deviation between the spatial frequency band of the object and the evaluation band obtained using the low-pass filter increases. Therefore, in the case where the evaluation band obtained using the low-pass filter is low, the evaluation band after the change (the evaluation area W1) is set to be wide (e.g., 100 pixels in the horizontal direction). Conversely, in the case where the evaluation band obtained using the low-pass filter is high, deviation between the spatial frequency band of the object and the evaluation band obtained using the low-pass filter is reduced. Therefore, in the case where the evaluation band obtained using the low-pass filter is high (although lower than the evaluation band obtained using the high-pass filter), the evaluation band after the change (the evaluation area W1) is set to be narrow (e.g., 50 pixels in the horizontal direction).

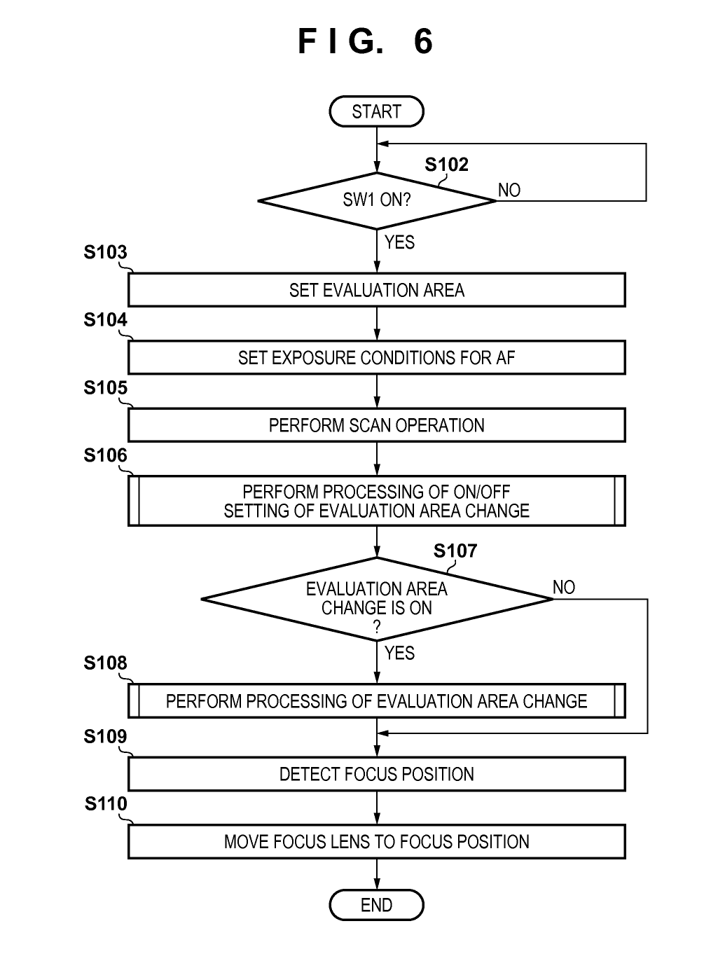

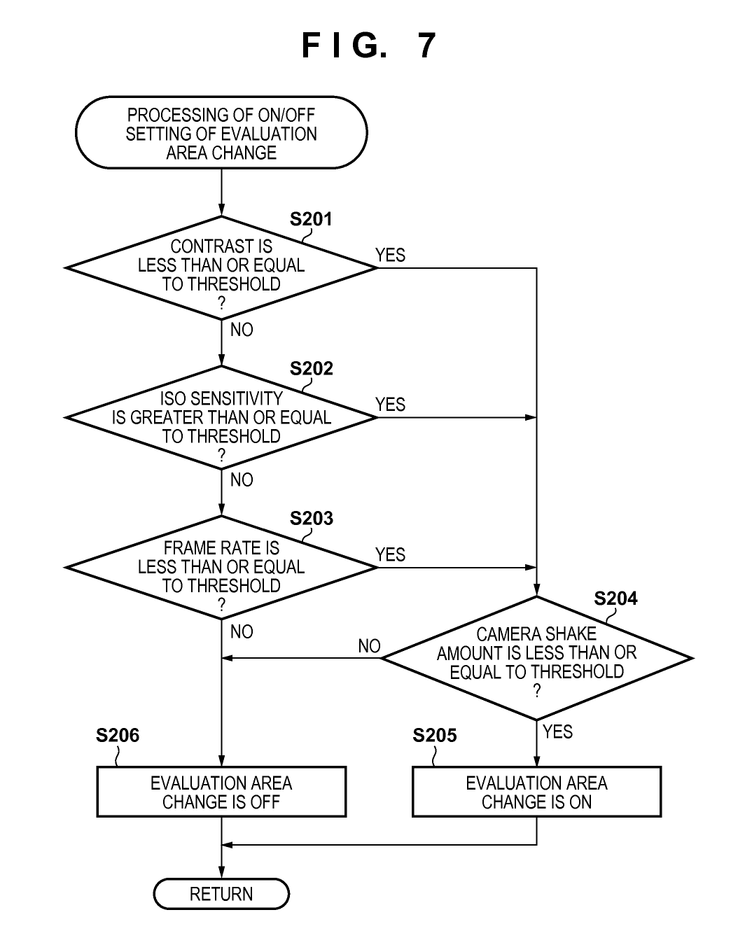

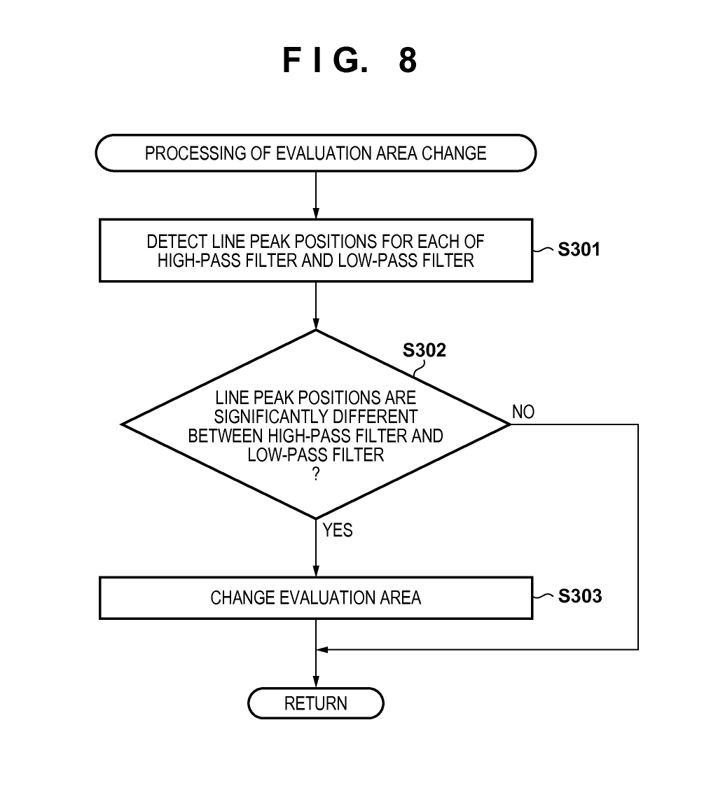

Next, AF processing executed by the image capturing apparatus 100 will be described with reference to FIG. 6. The processing of each step of this flowchart is realized, unless otherwise stated, by the CPU 121 executing a predetermined program and controlling each unit of the image capturing apparatus 100 (the same is applied to FIG. 7 and FIG. 8). When the image capturing apparatus 100 is in a shooting mode, the processing of this flowchart starts.

First, in step S102, the image capturing apparatus 100 determines whether or not a release switch is in a half-pressed state (SW1 is in an ON state). Determination in step S102 is repeated until SW1 is ON, and the procedure advances to step S103 when SW1 is ON.

In step S103, the image capturing apparatus 100 sets an evaluation area. Setting of the evaluation area may be performed in accordance with an instruction from a photographer, or may be performed automatically. A plurality of evaluation areas may also be set. As an example, the image capturing apparatus 100 performs face detection and sets the position of the detected face as the evaluation area.

In step S104, the image capturing apparatus 100 sets exposure conditions for AF. Specifically, the image capturing apparatus 100 performs evaluation photometry on the evaluation area, and sets a diaphragm value, ISO sensitivity, a frame rate and the like so as to achieve a suitable exposure amount. In step S105, the image capturing apparatus 100 moves the third lens group 105 to an initial position in order to start a scan operation for the contrast AF.

In step S106, the image capturing apparatus 100 performs the processing of ON/OFF setting of evaluation area change. Detailed description on the processing of the ON/OFF setting of the evaluation area change will be given later with reference to FIG. 7. In step S107, the image capturing apparatus 100 determines whether or not the evaluation area change is set to ON. In the case of ON, the procedure advances to step S108, and in the case of OFF, the procedure advances to step S109. Note that the processes of steps S106 and S107 may be omitted. In this case, the processing of this flowchart advances from step S105 to step S108.

In step S108, the image capturing apparatus 100 performs the processing of the evaluation area change. Detailed description of the processing of the evaluation area change will be given later with reference to FIG. 8.

In step S109, the image capturing apparatus 100 detects a focus position using the contrast AF control based on the focus evaluation values obtained with the peak value integration unit 204 of the contrast signal processing circuit 124. In step S110, the image capturing apparatus 100 moves the third lens group 105 to the focus position detected in step S109.

Next, the processing of the ON/OFF setting of the evaluation area change in step S106 in FIG. 6 will be described with reference to FIG. 7. In step S201, the image capturing apparatus 100 determines whether or not the contrast of the evaluation area is less than or equal to a threshold. For example, the image capturing apparatus 100 calculates the difference between a maximum value and a minimum value of luminance for each line of the evaluation area, and determines the contrast. In the case where the contrast is less than or equal to a threshold, the procedure advances to step S204, and otherwise, the procedure advances to step S202. In the case where the contrast is less than or equal to a threshold, there is the possibility that focusing accuracy deteriorates due to the S/N ratio of focus evaluation values decreasing. Therefore, via step S204, in step S205, the image capturing apparatus 100 sets the evaluation area change to ON. Note that detailed description on the processing of step S204 will be given later.

In step S202, the image capturing apparatus 100 determines whether or not ISO sensitivity is greater than or equal to a threshold (e.g., greater than or equal to ISO 1600). In the case where the ISO sensitivity is greater than or equal to the threshold, the procedure advances to step S204, and otherwise, the procedure advances to step S203. In the case where the ISO sensitivity is greater than or equal to the threshold, there is the possibility that focusing accuracy deteriorates due to the S/N ratio of focus evaluation values decreasing. Therefore, via step S204, in step S205, the image capturing apparatus 100 sets the evaluation area change to ON. Note that detailed description on the processing of step S204 will be given later.

In step S203, the image capturing apparatus 100 determines whether or not a frame rate is less than or equal to a threshold (for example, less than or equal to 30 fps). In the case where the frame rate is less than or equal to the threshold, the procedure advances to step S204, and otherwise, the procedure advances to step S206. In the case where the frame rate is less than or equal to the threshold, it is conceived that the object is relatively dark. Therefore, there is the possibility that focusing accuracy deteriorates due to the S/N ratio of focus evaluation values decreasing. Therefore, via step S204, in step S205, the image capturing apparatus 100 sets the evaluation area change to ON. Note that detailed description of the processing of step S204 will be given later.

In step S204, the image capturing apparatus 100 determines whether or not a camera shake amount is less than or equal to a threshold. In the case where the camera shake amount is less than or equal to the threshold, the procedure advances to step S205, and otherwise, the procedure advances to step S206. In the case where the camera shake amount is greater than the threshold, there is the possibility of a state where a desired object is moving in the evaluation area. In this case, if the evaluation area is reduced due to the processing of the evaluation area change, there is the possibility that a wrong area is designated as the evaluation area. The image capturing apparatus 100 thus prohibits change of the evaluation area using the evaluation area change unit 141. In other words, in step S206, the image capturing apparatus 100 sets the evaluation area change to OFF. Note that the camera shake amount can be calculated based on the output of an acceleration sensor (not illustrated) of the image capturing apparatus 100, for example.

As described above, in the case where the contrast is low, in the case where the ISO sensitivity is high, or in the case where the frame rate is low, the image capturing apparatus 100 sets the evaluation area change to ON. However, in these cases, if the camera shake amount is large, the image capturing apparatus 100 sets the evaluation area change to OFF.

Next, the processing of the evaluation area change in step S108 in FIG. 6 will be described with reference to FIG. 8. In step S301, the image capturing apparatus 100 detects line peak positions as for each of the high-pass filter and the low-pass filter (the BPFs 202 and 205 in FIG. 2).

In step S302, the image capturing apparatus 100 determines whether or not the line peak positions are significantly different between the high-pass filter and the low-pass filter. For example, in the case where the variation in the line peak positions obtained using the high-pass filter is greater than the variation in the line peak positions obtained using the low-pass filter by more than a predetermined degree, the image capturing apparatus 100 determines that line peak positions are significantly different. In the case where the line peak positions are significantly different, the procedure advances to step S303, and otherwise, the processing of this flowchart is ended.

In step S303, the image capturing apparatus 100 changes the evaluation area based on line peak values corresponding to the low-pass filter. Details of change of the evaluation area is as described earlier with reference to FIG. 3, and for example, the evaluation area is changed from the evaluation area W0 to the evaluation area W1.

Note that the processing of step S302 may be omitted. In this case, regardless of the line peak positions corresponding to the high-pass filter, the processing of step S303 is executed. Moreover, in this case, in step S301, it is not necessary to detect the line peak positions corresponding to the high-pass filter.

As described above, in accordance with the first embodiment, the image capturing apparatus 100 performs low-pass filter processing on captured image signals of a predetermined evaluation area, and detects a line peak position of contrast evaluation values for each line of the evaluation area. The image capturing apparatus 100 then changes the evaluation area based on the detected line peak positions. The image capturing apparatus 100 then performs high-pass filter processing on the captured image signals of the evaluation area after the change and calculates focus evaluation values based on the high frequency components obtained in this manner. Thereby, focusing accuracy can be improved.

### Other Embodiments

Embodiments of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-231972, filed Nov. 14, 2014, which is hereby incorporated by reference herein in its entirety.

What is claimed is:

1. A focus control apparatus comprising:
a first extraction unit configured to extract frequency components of a first band from a predetermined evaluation area of image data generated by an image capturing unit;
a change unit configured to change the evaluation area based on the frequency components extracted by the first extraction unit, so that the evaluation area after the change is narrower than the evaluation area before the change;
a second extraction unit configured to extract, from the evaluation area after the change, frequency components of a second band that includes a higher band than the first band; and
a calculation unit configured to calculate a focus evaluation value for performing focus control of the image capturing unit based on the frequency components extracted by the second extraction unit.

2. The focus control apparatus according to claim 1,
wherein the change unit:
detects a position at which a contrast evaluation value is maximum in the evaluation area, based on the frequency components extracted by the first extraction unit; and
changes the evaluation area so that the evaluation area after the change includes the detected position.

3. A focus control apparatus according to claim 2,
wherein the change unit:
detects a line peak position that is a position at which a contrast evaluation value is maximum in a line, based on the frequency components extracted by the first extraction unit, for each of a plurality of lines included in the evaluation area; and
changes the evaluation area so that the evaluation area after the change includes a plurality of line peak positions that correspond to the plurality of lines.

4. The focus control apparatus according to claim 3,
wherein the change unit changes the evaluation area so that the evaluation area after the change includes, among the plurality of line peak positions, a line peak position at which a contrast evaluation value is greater than or equal to a threshold.

5. The focus control apparatus according to claim 1,
wherein the change unit changes the evaluation area in a case where contrast of the evaluation area is less than or equal to a threshold.

6. The focus control apparatus according to claim 1,
wherein the change unit changes the evaluation area in a case where ISO sensitivity of the image capturing unit is greater than or equal to a threshold.

7. The focus control apparatus according to claim 1,
wherein the change unit changes the evaluation area in a case where a frame rate of the image capturing unit is less than or equal to a threshold.

8. The focus control apparatus according to claim 1, further comprising:
a prohibition unit configured to prohibit change of the evaluation area by the change unit in a case where a camera shake amount of an image capturing apparatus provided with the image capturing unit is greater than a threshold.

9. The focus control apparatus according to claim 1,
wherein the calculation unit:
detects a line peak position that is a position at which a contrast evaluation value is maximum in a line, based on the frequency components extracted by the second extraction unit, for each of a plurality of lines included in the evaluation area after the change; and
calculates the focus evaluation value based on contrast evaluation values of a plurality of line peak positions that correspond to the plurality of lines of the evaluation area after the change.

10. An image capturing apparatus comprising:
an image capturing unit;
a first extraction unit configured to extract frequency components of a first band from a predetermined evaluation area of image data generated by the image capturing unit;
a change unit configured to change the evaluation area based on the frequency components extracted by the first extraction unit, so that the evaluation area after the change is narrower than the evaluation area before the change;
a second extraction unit configured to extract, from the evaluation area after the change, frequency components of a second band that includes a higher band than the first band; and
a calculation unit configured to calculate a focus evaluation value for performing focus control of the image capturing unit based on the frequency components extracted by the second extraction unit.

11. A method for controlling a focus control apparatus, comprising:
a first extraction step of extracting frequency components of a first band from a predetermined evaluation area of image data generated by an image capturing unit;
a change step of changing the evaluation area based on the frequency components extracted in the first extraction step, so that the evaluation area after the change is narrower than the evaluation area before the change;
a second extraction step of extracting, from the evaluation area after the change, frequency components of a second band that includes a higher band than the first band; and
a calculation step of calculating a focus evaluation value for performing focus control of the image capturing unit based on the frequency components extracted in the second extraction step.

12. A non-transitory computer-readable storage medium which stores a program for causing a computer to execute a method for controlling a focus control apparatus, the method comprising:
a first extraction step of extracting frequency components of a first band from a predetermined evaluation area of image data generated by an image capturing unit;
a change step of changing the evaluation area based on the frequency components extracted in the first extraction step, so that the evaluation area after the change is narrower than the evaluation area before the change;
a second extraction step of extracting, from the evaluation area after the change, frequency components of a second band that includes a higher band than the first band; and
a calculation step of calculating a focus evaluation value for performing focus control of the image capturing unit based on the frequency components extracted in the second extraction step.
